(19) United States
(12) Patent Application Publication
(10) Pub. No.: US 2010/0010153 A1
(43) Pub. Date: Jan. 14, 2010

(54) WATER-SOLUBLE BINDERS FOR PAPER COATING SLIPS

(75) Inventors: Robert Feuerhake, Mannheim (DE); Dirk Lawrenz, Hassloch (DE); Hans-Joachim Haehnle, Neustadt (DE); Juergen Schmidt-Thuemmes, Neuhofen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/526,272

(22) PCT Filed: Feb. 4, 2008
(86) PCT No.: PCT/EP08/51304

§ 371 Date: Aug. 7, 2009

(30) Foreign Application Priority Data
Feb. 8, 2007 (EP) 07101962.4

(51) Int. Cl. C09D 133/02

(52) U.S. Cl. 524/556

(57) ABSTRACT

Paper coating slips comprising
a) one or more binders
b) if appropriate, a thickener
c) if appropriate, a fluorescent or phosphorescent dye, in particular as an optical brightener
d) pigments or fillers
e) further assistants, e.g. leveling agents or other dyes,
   wherein at least 40% by weight of the total amount of the binders a) comprise a synthetic, water-soluble, anionic polymer (anionic polymer for short) and less than 50% by weight of the total amount of the binders a) are emulsion polymers.

The invention relates to paper coating slips comprising
a) one or more binders
b) if appropriate, a thickener
c) if appropriate, a fluorescent or phosphorescent dye, in particular as an optical brightener
d) pigments or fillers
e) further assistants, e.g. leveling agents or other dyes,
   at least 40% by weight of the total amount of the binders a) comprising a synthetic, water-soluble, anionic polymer (anionic polymer for short) and less than 50% by weight of the total amount of the binders a) being emulsion polymers.

Paper coating slips usually comprise polymeric binders and pigments, usually white pigments. Base papers acquire the desired mechanical and optical properties through paper coating slips. The pigments should be fixed on the paper and the cohesion in the coating obtained should be ensured by the binder. The papers coated with the paper coating slips should in particular be printable.

In the printing process, for example in an offset printing press, strong tensile forces act on the coated paper (paper coat) owing to the high viscosity of the printing ink. The resistance which the paper coat offers to these forces is referred to as pick resistance. The distinction is made between dry pick resistance and wet pick resistance. The wet pick resistance is particularly important in water-based offset printing since the printing ink comes into contact with a water-moist paper in the second printing unit, and the paper coat must have sufficient binding power under these conditions.

Emulsion polymers are usually used as binders. In addition to the pigments and emulsion polymers, paper coating slips may comprise further constituents. For example, the concomitant use of additional binders, so-called cobinders, is known. EP-A-19 170, EP-A 343 007, DE-A 103 42 517 and US 2005/0261394 describe water-soluble polymers as cobinders. However, the amount of cobinders is in each case substantially smaller than that of the emulsion polymers.

Water-soluble polymers are moreover a constituent of pigment-free compositions for further paper finishing. WO 03/021041 describes, for example, the use of cationic polymers for increasing the whiteness of paper.

In the area of paper coating slips, there is in principle a need for novel, possibly also more economical binders which, if appropriate, may replace the emulsion polymers. The optical and mechanical properties of the coated papers should, however, as far as possible not be impaired by use of the novel binders.

An object of the invention was therefore novel binders for paper coating slips.

According to the invention, the paper coating slip comprises
a) one or more binders
b) if appropriate, a thickener
c) if appropriate, a fluorescent or phosphorescent dye, in particular as an optical brightener
d) pigments or fillers
e) further assistants, e.g. leveling agents or other dyes.

### Regarding the Anionic Polymers as Binders

A substantial feature is that at least 40% by weight of the total amount of the binders a) comprise a synthetic, water-soluble, anionic polymer (anionic polymer for short) and less than 50% by weight of the total amount of the binders a) are emulsion polymers.

Anionic polymers are those which comprise anionic groups, e.g. carboxylate groups, phosphonate groups or sulfonate groups, bonded to the polymer skeleton. The associated cation is, for example, a metal cation not bonded to the polymer. The anionic polymer may also comprise cationic groups bonded to the polymer skeleton, but the polymer as a whole is anionic, i.e. the anionic groups must predominate.

The anionic polymer preferably comprises at least 0.01 mol, particularly preferably at least 0.05 mol and very particularly preferably at least 0.1 mol of acid groups per 100 g of anionic polymer; the content of the acid groups is in general not greater than 1.4 mol, in particular not greater than 1.2 mol or not greater than 1 mol of acid groups/100 g of anionic polymer.

Suitable acid groups are, for example, sulfonic acid groups, phosphonic acid groups or carboxylic acid groups. Carboxylic acid groups are preferred.

Preferably, at least 20 mol %, particularly preferably at least 40 mol %, very particularly preferably at least 60 mol %, in a particular embodiment 100 mol %, of the acid groups are present in anionic form, i.e. as a salt.

The cationic opposite ion to the anionic acid groups may be a monovalent or polyvalent, e.g. divalent or trivalent, opposite ion; monovalent cationic opposite ions are preferred. For example, the cations of the alkali metals, in particular of sodium or potassium, are suitable. Nitrogen compounds, for example the ammonium cation and derivatives thereof, are also suitable, and the sodium and potassium cations are preferred.

The solubility of the anionic polymer in water is preferably greater than 50 g, particularly preferably greater than 100 g, very particularly preferably greater than 150 g, of anionic polymer/1 liter of water (21° C., 1 bar).

Any desired polymers, e.g. polyadducts, polycondensates or polymers obtained by free radical polymerization, are suitable as the anionic polymer.

The anionic polymers comprise the acid or salt groups, for example, by virtue of the fact that either one component already has these groups during the preparation or by virtue of the fact that chemical transformations are subsequently carried out on the polymer.

The anionic polymer is preferably a polymer obtainable by free radical polymerization of ethylenically unsaturated compounds (monomers).

The anionic polymer preferably comprises the acid or salt groups by copolymerization with suitable monomers which comprise such groups or groups which can be converted into such groups.

Suitable such monomers are monomers having an acid group or salt group derived therefrom. For example, monomers having an acid anhydride group which can subsequently be readily converted into acid groups and salts thereof are, however, also suitable; in the end, after the transformation, the latter is also a monomer having an acid or salt group. Monomers having an acid or salt group are referred to below as acid monomers.

In particular, at least 5% by weight, preferably at least 10% by weight, particularly preferably at least 20% by weight and very particularly preferably at least 30% by weight of the monomers of which the anionic polymer is composed are acid monomers.

Preferred acid monomers are, for example, monomers having a carboxylic acid group, a sulfonic acid group or a phosphonic acid group; monomers having a carboxylic acid group are particularly preferred.

For example, acrylic acid, methacrylic acid, maleic acid or itaconic acid as monomers having a carboxylic acid group, and vinylphosphonic acid and acrylamidosulfonic acids, in particular acrylamide-2-methylpropanesulfonic acid, may be mentioned.

The anionic polymer may comprise further monomers in addition to the acid monomers.

Suitable further monomers are monomers selected from C₁-C₂₀-alkyl(meth)acrylates, vinyl esters of carboxylic acids comprising up to 20 carbon atoms, vinylaromatics having up to 20 carbon atoms, vinyl halides, aliphatic hydrocarbons having 2 to 8 carbon atoms and one or two double bonds, monomers comprising ether groups, in particular vinyl ethers of alcohols comprising 1 to 10 carbon atoms (ether monomers) and monomers having at least one nitrogen atom in the molecule (nitrogen monomers for short) or mixtures of these monomers.

In particular, vinyl carboxamides may be mentioned as nitrogen monomers. Preferred vinyl carboxamides are those of the formula (I):

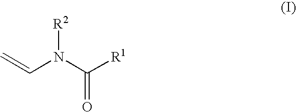

In formula (I), R¹ and R², independently of one another, are hydrogen or C1 to C20-alkyl, it being possible for the alkyl radical to be straight-chain or branched.

R¹ and R², independently of one another, are preferably hydrogen or C1 to C10-alkyl, particularly preferably hydrogen or C1 to C4-alkyl, very particularly preferably hydrogen or methyl and in particular hydrogen.

R¹ and R² together may also form a straight or branched chain comprising 2 to 8 carbon atoms, preferably a chain comprising 3 to 6 carbon atoms and particularly preferably a chain comprising 3 to 5 carbon atoms, so that a ring forms. If appropriate, one or more carbon atoms may be replaced by heteroatoms, such as, for example, oxygen, nitrogen or sulfur.

Examples of the radicals R¹ and R² are methyl, ethyl, isopropyl, n-propyl, n-butyl, isobutyl, sec-butyl, tert-butyl, n-hexyl, n-heptyl, 2-ethylhexyl, n-octyl, n-decyl, n-undecyl, n-dodecyl, n-tetradecyl, n-hexadecyl, n-octadecyl or n-eicosyl.

Examples of radicals R¹ and R² which together form a chain are 1,2-ethylene, 1,2-propylene, 1,3-propylene, 2-methyl-1,3-propylene, 2-ethyl-1,3-propylene, 1,4-butylene, 1,5-pentylene, 2-methyl-1,5-pentylene, 1,6-hexylene or 3-oxa-1,5-pentylene.

Examples of those N-vinylcarboxamides according to formula (I) are N-vinylformamide, N-vinylacetamide, N-vinylpropionamide, N-vinylbutyramide, N-vinylisobutyramide, N-vinyl-2-ethylhexanamide, N-vinyldecanamide, N-vinyldodecanamide, N-vinylstearamide, N-methyl-N-vinylformamide, N-methyl-N-vinylacetamide, N-methyl-N-vinylpropionamide, N-methyl-N-vinylbutyramide, N-methyl-N-vinylisobutyramide, N-methyl-N-vinyl-2-ethylhexanamide, N-methyl-N-vinyidecanamide, N-methyl-N-vinyldodecanamide, N-methyl-N-vinylstearamide, N-ethyl-N-vinylformamide, N-ethyl-N-vinylacetamide, N-ethyl-N-vinylpropionamide, N-ethyl-N-vinylbutyramide, N-ethyl-N-vinylisobutyramide, N-ethyl-N-vinyl-2-ethylhexanamide, N-ethyl-N-vinyldecanamide, N-ethyl-N-vinyldodecanamide, N-ethyl-N-vinylstearamide, N-isopropyl-N-vinylformamide, N-isopropyl-N-vinylacetamide, N-isopropyl-N-vinylpropionamide, N-isopropyl-N-vinylbutyramide, N-isopropyl-N-vinylisobutyramide, N-isopropyl-N-vinyl-2-ethylhexanamide, N-isopropyl-N-vinyldecanamide, N-isopropyl-N-vinyldodecanamide, N-isopropyl-N-vinylstearamide, N-n-butyl-N-vinylformamide, N-n-butyl-N-vinylacetamide, N-n-butyl-N-vinylpropionamide, N-n-butyl-N-vinylbutyramide, N-n-butyl-N-vinylisobutyramide, N-n-butyl-N-vinyl-2-ethylhexanamide, N-n-butyl-N-vinyidecanamide, N-n-butyl-N-vinyldodecanamide, N-n-butyl-N-vinylstearamide, N-vinylpyrrolidone or N-vinylcaprolactam.

N-vinylformamide, N-vinylacetamide, N-methyl-N-vinylformamide, N-methyl-N-vinylacetamide, N-vinylpyrrolidone or N-vinylcaprolactam is preferred and N-vinylformamide (VFA) is particularly preferred.

The vinylcarboxamides may eliminate carboxylic acid groups under hydrolysis conditions and are then present as vinylamines. Under appropriate pH conditions, amines form cationic groups. Elimination of the carboxylic acid groups from the vinylcarboxamides is therefore not preferred in the context of this invention. If such an elimination takes place, the number of amino groups which are or can be made cationic should be smaller than the number of anionic groups, in particular less than half the number of the anionic groups.

It is preferable if vinylcarboxamides are incorporated as polymerized units in an amount of more than 50 mol %, in particular more than 80 mol %, very particularly preferably more than 95 mol % or 100 mol % in the polymer as vinylcarboxamides, i.e. without elimination of the carboxylic acid group.

In addition to the vinylcarboxamides, methacrylamide and acrylamide are furthermore preferred as nitrogen monomers.

Vinylimidazole is also preferred.

Anionic polymers which comprise in addition to acid monomers (ether monomers) and/or or (nitrogen monomers) are preferred.

Nitrogen monomers are particularly preferred and vinylcarboxamides are very particularly preferred, in particular vinylformamide, and (meth)acrylamide or vinylimidazole.

Nitrogen monomers selected from vinylformamide or (meth)acrylamide or vinylimidazole may be mentioned in particular.

Vinylformamide is very particularly preferred.

The anionic polymers may consist exclusively of the acid monomers; anionic polymers which, in addition to the acid monomers, are composed of at least 5% by weight of further monomers selected from monomers having at least one ether group (ether monomers) or monomers having at least one nitrogen atom (nitrogen monomers) are preferred.

The anionic polymers composed of

from 5 to 95% by weight of acid monomers
from 5 to 95% by weight of further monomers, in particular nitrogen monomers
from 0 to 30% by weight of auxiliary monomers
are particularly preferred.

The anionic polymers composed of

from 15 to 85% by weight of acid monomers
from 15 to 85% by weight of further monomers, in particular nitrogen monomers
from 0 to 20% by weight of auxiliary monomers
are very particularly preferred.

In a particular embodiment, the anionic polymers consist of

from 25 to 75% by weight of acid monomers
from 25 to 75% by weight of further monomers, in particular nitrogen monomers
from 0 to 20% by weight of auxiliary monomers.

In a very particular embodiment, the anionic polymers consist of

from 35 to 65% by weight of acid monomers
from 35 to 65% by weight of further monomers, in particular nitrogen monomers
from 0 to 20% by weight of auxiliary monomers

In the above compositions, the proportion of the auxiliary monomers may also be from 0 to 10% by weight, in particular from 0 to 5% by weight or 0% by weight.

The preparation of the anionic polymers is known to the person skilled in the art and can be effected in particular by solution polymerization in water.

The preparation is also described, for example, in WO 03/021041.

The polymerization temperatures are usually in the range from 30 to 200° C., preferably from 40 to 110° C., particularly preferably from 40 to 100° C., if appropriate at reduced or superatmospheric pressure. Suitable initiators are, for example, azo and peroxy compounds and the customary redox initiator systems, such as combinations of hydrogen peroxide and reducing compounds, e.g. sodium sulfite, sodium bisulfite, sodium formaldehyde sulfoxylate and hydrazine. These systems can, if appropriate, additionally comprise small amounts of a heavy metal salt.

The anionic polymers are preferably prepared by solution polymerization in water. Water-soluble azo compounds, such as 2,2′-azobis(2-methylpropionamidine) dihydrochloride, 2,2′-azobis-(4-methoxy-2,4-dimethylvaleronitrile), 2,2′-azobis-(2-methyl-N-phenylpropionamidine) dihydrochloride, 2,2′-azobis(isobutyronitrile), 2,2′-azobis-(2-amidinopropane) hydrochloride or 4,4′-azobis(4′-cyanopentanoic acid), are preferably used as the polymerization initiator.

The amount of the initiators is in general from 0.1 to 10% by weight, preferably from 0.5 to 5% by weight based on the monomers to be (co)polymerized. It is also possible to use a plurality of different initiators in the (co)polymerization.

For example, water, alcohols, such as methanol, ethanol, n-propanol or isopropanol, n-butanol or isobutanol, or ketones, such as acetone, methyl ethyl ketone, diethyl ketone or isobutyl methyl ketone, may be used as solvents or diluents for the polymerization.

In order to prepare low molecular weight polymers, the polymerization can be carried out in the presence of a regulator. Suitable regulators are, for example, secondary alcohols, such as isopropanol and sec-butanol, hydroxylamine, formic acid and mercapto compounds, such as mercaptoethanol, mercaptopropanol, mercaptobutanol, thioglycolic acid, thiolactic acid, tert-butyl mercaptan, octyl mercaptan and dodecyl mercaptan. The regulators are usually used in amounts of from 0.01 to 5% by weight, based on the monomers used. If secondary alcohols are used as regulators the (co)polymerization can also be effected in the presence of substantially larger amounts, for example in amounts up to 80% by weight, based on the monomers. In these cases, the secondary alcohols are simultaneously solvents for the monomers.

The polymers thus obtainable have as a rule K values of from 20 to 300, preferably from 50 to 250. The K values stated in this document are determined according to H. Fikentscher in 5% strength aqueous sodium chloride solution at pH 7, 25° C. and a polymer concentration of 0.1% by weight.

The pH of the aqueous solution obtained or subsequently of the paper coating slip was preferably adjusted to values of from 6 to 10, in particular from 7 to 9. The acid groups are then present as salt groups.

### Regarding the Binders as a Whole

In addition to the anionic polymer the paper coating slip may comprise further binders.

Emulsion polymers or natural binders, such as starch, are particularly suitable.

Suitable and usually used emulsion polymers preferably comprise at least 40% by weight, preferably at least 60% by weight, particularly preferably at least 80% by weight, of so-called main monomers.

The main monomers are selected from C₁-C₂₀-alkyl(meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds or mixtures of these monomers.

For example, alkyl(meth)acrylate having a C₁-C₁₀-alkyl radical, such as methyl methacrylate, methyl acrylate, n-butyl acrylate, ethyl acrylate and 2-ethylhexyl acrylate may be mentioned.

Mixtures of the alkyl(meth)acrylate are also particularly suitable.

Vinyl esters of carboxylic acids having 1 to 20 carbon atoms are, for example, vinyl laurate, vinyl stearate, vinyl propionate, vinyl versatate and vinyl acetate.

Suitable vinylaromatic compounds are vinyltoluene, α- and p-methylstyrene, α-butylstyrene, 4-n-butylstyrene, 4-n-decylstyrene and preferably styrene. Examples of nitriles are acrylonitrile and methacrylonitrile.

The vinyl halides are ethylenically unsaturated compounds substituted by chlorine, fluorine or bromine, preferably vinyl chloride and vinylidine chloride.

For example, vinyl methyl ether or vinyl isobutyl ether may be mentioned as vinyl ethers. Vinyl ethers of alcohols comprising 1 to 4 carbon atoms are preferred.

Ethylene, propylene, butadiene, isoprene and chloroprene may be mentioned as hydrocarbons having 2 to 8 carbon atoms and one or two olefinic double bonds.

Preferred main monomers are C₁-C₁₀-alkyl(meth)acrylates and mixtures of alkyl (meth)acrylates with vinylaromatics, in particular styrene, or hydrocarbons having 2 double bonds, in particular butadiene, or mixtures of such hydrocarbons with vinylaromatics, in particular styrene.

In the case of mixtures of aliphatic hydrocarbons (in particular butadiene) with vinylaromatics (in particular styrene) the ratio may be, for example, from 10:90 to 90:10, in particular from 20:80 to 80:20.

Particularly preferred main monomers are butadiene and the above mixtures of butadiene and styrene.

In addition to the main monomers, the polymer may comprise further monomers, for example monomers having carboxylic acid, sulfonic acid or phosphonic acid groups. Carboxylic acid groups are preferred. For example, acrylic acid, methacrylic acid, itaconic acid, maleic acid or fumaric acid may be mentioned. The content of ethylenically unsaturated acids in the emulsion polymer is in general less than 5% by weight.

Further monomers are, for example, also monomers comprising hydroxyl groups, in particular C₁-C₁₀-hydroxyalkyl(meth)acrylates, or amides, such as (meth)acrylamide.

The preparation of the polymers is effected by emulsion polymerization, and the polymers are therefore emulsion polymers.

A substantial feature of the present invention is that emulsion polymers are not required as binders and can be replaced by the anionic polymers.

Preferably less than 30% by weight, particularly preferably less than 20% by weight, particularly preferably less than 10% by weight, of the binders a) are therefore emulsion polymers.

In a particular embodiment, the paper coating slip comprises no emulsion polymers.

Natural binders, such as starch, may also be concomitantly used but are not absolutely essential.

In this context, starch is understood as meaning any natural, modified or degraded starch. Natural starches may consist of amylose, amylopectin or mixtures thereof. Modified starches may be oxidized starch, starch esters or starch ethers.

The molecular weight of the starch can be reduced by hydrolysis (degraded starch). Suitable degradation products are oligosaccharides or dextrins.

Preferred starches are cereal, corn and potato starch. Cereal and corn starch are particularly preferred, and cereal starch is very particularly preferred.

The proportion of the anionic polymer in the binders a) is at least 50% by weight, particularly preferably at least 60% by weight and in particular at least 70% by weight (solid, i.e. without water or other solvents liquid at 21° C., 1 bar).

In a particular embodiment, the proportion of the anionic polymer in the binders a) is at least 80% by weight or 95% by weight. In particular, the binders a) may also exclusively comprise the anionic polymer.

The amount of the binders a) altogether is preferably from 1 to 50 parts by weight, particularly preferably from 1 to 20 parts by weight, per 100 parts by weight of pigment or filler (solid, i.e. without water of other solvents liquid at 21° C., 1 bar). An advantage of the invention is that the proportion of binder as a whole can be reduced; thus, the amount of binder a) may be in particular less than 10, even less than 8 or less than 7, parts by weight per 100 parts by weight of pigment or filler and is in general at least 1 or 2 parts by weight per 100 parts by weight of pigment or filler (all data are based on solid, i.e. without water or other solvents liquid at 21° C., 1 bar).

### Regarding the Further Constituents of the Paper Coating Slip

In addition to synthetic polymers, suitable thickeners b) are in particular celluloses, preferably carboxymethylcellulose.

Customary fluorescent or phosphorescent dyes are in particular stilbenes, which act as optical brighteners.

The pigment or filler d) generally comprises inorganic solids, and white pigments, i.e. barium sulfate, calcium carbonate, calcium sulfoaluminate, kaolin, talc, titanium dioxide, zinc oxide, chalk or coating clay, are particularly suitable.

It is preferably an aqueous paper coating slip; in particular, it already comprises water through the formulation form of the constituents (aqueous solution of the anionic polymer, aqueous pigment slurries); the desired viscosity can be established by addition of further water.

Customary solids contents of the paper coating slips are in the range from 30 to 60% by weight.

### Preparation and Use

The preparation of the paper coating slip can be effected by customary methods.

The constituents are combined and mixed in a customary manner.

The paper coating slip is preferably applied to uncoated base papers or uncoated cardboard.

The amount is in general from 1 to 50 g, preferably from 5 to 30 g (solid, i.e. without water or other solvents liquid at 21° C., 1 bar) per 1 square meter.

The coating can be effected by customary coating methods, including curtain coating.

The coated papers and cardboard have good performance characteristics, in particular high gloss and good pick resistance. They can be readily printed on in the customary printing processes, such as letterpress, gravure and offset printing. The amount of binder as a whole can be reduced. Furthermore, less thickener or other cobinders are required. Even without a thickener, the water retention of the paper coating slips is very good.

### EXAMPLES

### Preparation of Water-Soluble Anionic Polymers

### Abbreviations: N-vinylformamide: VFA

acrylic acid: AA
acrylamide: AM
maleic acid: MA
2,2′-azobis(2-methylpropionamide) dihydrochloride: Wako V 50

The K values were determined according to H. Fikentscher, Cellulose-Chemie, volume 13, 58-64 and 71-74 (1932) as a 0.1% strength solution in 5% strength sodium chloride solution.

The data in % are in % by weight.

Unless stated otherwise, the solutions are aqueous solutions.

### Example 1

### VFA:AA=40:60 (Mol %)

Initially taken mixture: 574.8 g of demineralized water
1.9 g of phosphoric acid (75%)
3.3 g of sodium hydroxide solution (25%)

Feed 1: 300.00 g of demineralized water
400.3 g of sodium acrylate solution (32%)
65.2 g of VFA (99%)

Feed 2: 68.4 g of Wako V 50 solution (1%)

Feed 3: 16.3 g of Wako V 50 solution (1%)

Feed 4: 370.0 g of demineralized water

Before the reaction, the pH of the initially taken mixture and the pH of feed 1 are adjusted to 6.5. The initially taken mixture is heated to 76° C. in a 2 l reactor. Reduced pressure of about 357 mbar is then applied to the reaction vessel. At this temperature, feeds 1 and 2 are started simultaneously, feed 1 being added in the course of two hours and feed 2 in the course of three hours. After five hours altogether, feed 3 is added in the course of 5 min and polymerization is continued for a further two hours.

A clear solution having a solids content of 12.65% is obtained. The K value is 107.1.

### Example 2

### VFA:AA=60:40 (Mol %)

Initially taken mixture: 887.6 g of demineralized water
4.3 g of phosphoric acid (85%)
6.0 g of NaOH (25%)

Feed 1: 571.0 g of sodium acrylate solution (38%)

Feed 2: 248.7 g of VFA (99%)

Feed 3: 8.24 g of Wako V-50
74.2 g of demineralized water

Before the reaction, the pH of the initially taken mixture and the pH of feed 1 are adjusted to 6.5. The initially taken mixture is heated to 78° C. in a 2 l reactor while gassing with nitrogen. Feeds 1-3 are added in parallel in the course of two hours. For completing the reaction, stirring is continued for a further three hours.

A clear solution having a solids content of 27.68% is obtained. The K value is 53.3.

### Example 3

### VFA:AA=50:50

Initially taken mixture: 524.5 g of demineralized water
3.8 g of phosphoric acid (75%)
7.4 g of sodium hydroxide solution (25%)

Feed 1: 705.1 g of sodium acrylate solution (32%)
172.4 g of VFA (99%)

Feed 2: 4.3 g of Wako V 50
81.7 g of demineralized water

Before the reaction, the pH of the initially taken mixture and the pH of feed 1 are adjusted to 6.5. The initially taken mixture is heated to 74° C. in a 2 l reactor while gassing with nitrogen. Feeds 1 and 2 are added simultaneously. Feed 1 is metered in in the course of two hours and feed 2 in the course of three hours. For completing the reaction, stirring is then continued for a further three hours. Thereafter, 200 g of water are added and distilled off again under reduced pressure.

A clear solution having a solids content of 27.80% is obtained. The K value is 82.6.

### Example 4

### VFA:AA=70:30 (Mol %)

Initially taken mixture: 906.1 g of demineralized water
4.3 g of phosphoric acid (85%)
6.0 g of sodium hydroxide solution (25%)

Feed 1: 428.2 g of sodium acrylate solution (38%)

Feed 2: 290.1 g of VFA (99%)

Feed 3: 8.24 g of Wako V 50
74.2 g of demineralized water

Before the reaction, the pH of the initially taken mixture and the pH of feed 1 are adjusted to 6.5. The initially taken mixture is heated to 75° C. in a 2 l reactor while gassing with nitrogen. Feeds 1 and 2 are started simultaneously. Feeds 1 and 2 are metered in the course of 2 hours, and feed 3 in the course of 2.5 hours. For completing the reaction, stirring is then continued for a further 3 hours.

A clear solution having a solids content of 27.85% is obtained. The K value is 62.9.

### Example 5

### VFA:AA=70:30 (Mol %)

Initially taken mixture: 803.00 g of demineralized water
5.10 g of phosphoric acid (75%)
7.6 g of sodium hydroxide solution (25%)

Feed 1: 274.75 g of demineralized water
161.90 g of acrylic acid
172.00 g of sodium hydroxide solution (50%)
376.90 g of VFA

Feed 2: 75.00 g of demineralized water
16.10 g of hypophosphorous acid (50%)
10.50 g of sodium hydroxide solution (50%)

Feed 3: 5.35 g of Wako V 50
60.00 g of demineralized water

Before the reaction, the pH of the initially taken mixture and the pH of feeds 1 and 2 are adjusted to 6.5. The initially taken mixture is heated to 76° C. in a 2 l reactor while gassing with nitrogen. At this temperature, the feeds are added in parallel, feed 1 and feed 2 being added in each case in two hours and feed 3 in the course of three hours. Polymerization is continued for a further two hours.

A clear solution having a solids content of 33.5% is obtained. The K value is 37.5.

### Example 6

### VFA:AA=30:70 (Mol %)

Initially taken mixture: 425.00 g of demineralized water
4.5 g of phosphoric acid (85%)
8.2 g of NaOH (25%)

Feed 1: 540.00 g of demineralized water
244.85 g of acrylic acid
277.00 g of sodium hydroxide solution (50%)
105.00 g of VFA

Feed 2: 4.20 g of Wako V 50
100.00 g of demineralized water

Initially taken mixture adjusted to pH 6.5 (+−0.3). Heated to 80° C. while gassing with nitrogen. At 80° C., feed 1 added in 2 hours and feed 2 added in 3 hours. Postpolymerization for 3 hours at 80° C.

### Example 7

### VFA/AA 40:60 Mol %

The preparation was carried out in a 4 liter stirred vessel.

| | | | |
|---|---|---|---|
| Initially | 977.2 | g | demineralized water |
| taken | 3.23 | g | phosphoric acid 75% } pH 6.5 |
| mixture | 5.61 | g | sodium hydroxide solution 25% |
| Feed 1 | 510 | g | demineralized water |
| | 110.84 | g | VFA 99% |
| | 680.51 | g | Na acrylate (32%) pH = 6.4 |
| Feed 2 | 116.28 | g | azo initiator V50 1% strength = 0.42% by |
| | | | weight based on monomers (VFA + AA) |
| Feed | 27.71 | g | azo initiator V50 1% strength = 0.1% by |
| | | | weight based on monomers (VFA + AA) |
| Feed 4 | 629 | g | demineralized water |
| Total | 3060.38 | g | 330 g dist. = 2730.38 g |

### Procedure:

Heat initially taken mixture to 74° C., gentle reflux (distilling off at 380 mbar) then start feeds 1+2. Run in feed 1 uniformly in 2 h and feed 2 in 3 h. After end of feed 2, continue stirring for a further 2 h.

Then add feed 3 in 5 min.

Postpolymerization for 2 h.

Cool and dilute with feed 4 during this procedure.

Distill of 330 g during the total run time.

The preparation was carried out according to the above procedure, and the solids content of the solution obtained was 12.5% by weight, with a K value of 104. The acid groups are present as salt (sodium acrylate).

### Preparation of the Paper Coating Slips

Paper coating slips were prepared by stirring the following aqueous constituents:

Hydrocarb® 90-Me aqueous slurry (calcium carbonate from company Omya)
Sterocoll® FD (commercially available thickener)
Styronal D 537 commercially available binder for paper coating slips, emulsion polymer based on butadiene and styrene
Anionic polymer from example 7

The amounts are stated in table 1.

The solids content was adjusted to 52% by weight with water, and the pH was from 8.5 to 8.7. The Brookfield viscosity was measured using a spindle no. 4 at 23° C. and two different speeds (20 and 100 rpm).

The water retention was determined according to Gradek. Good water retentivity is very important for the processing of a paper coating slip on large and high-speed paper coating units. For the test, an aqueous paper coating slip is brought into contact with a filter paper layer and the amount of water absorbed by the filter paper layer is determined gravimetrically. The greater the amount absorbed the poorer is the water retention of the paper coating slip; the amount absorbed is stated in g/square meter.

TABLE 1
Composition of coating slips S1 to S6
The numerical data are parts by weight, solid (i.e. without water)

| | S1 | S2 | S3 | S4 | S5 | S6 |
|---|---|---|---|---|---|---|
| Hydrocarb 90 | 100 | 100 | 100 | 100 | 100 | 100 |
| Sterocoll FD | 0.6 | 0 | 0 | 0 | 0 | 0 |
| Styronal D 537 | 5 | 4 | 3 | 2 | 1 | 0 |
| Polymer from | 0 | 1 | 2 | 3 | 4 | 5 |
| example 7 | | | | | | |
| Viscosity | 1820 | 920 | 1820 | 2610 | 3190 | 3650 |
| 20 rpm | | | | | | |
| (mPa · s) | | | | | | |
| Viscosity | 620 | 326 | 672 | 1004 | 1292 | 1572 |
| 100 rpm | | | | | | |
| (mPa · s) | | | | | | |
| Water | 110.2 | 185.5 | 165.5 | 148.7 | 127.3 | 116.9 |
| retention | | | | | | |

### Testing of the Performance Characteristics

The base paper used was a wood-free coating paper having a basis weight of 70 g/m². 10 g/m² of the paper coating slip were applied on one side on a laboratory coating machine. Drying was effected using an IR radiator. Before the testing of the performance characteristics, the paper passed through a laboratory calendar four times (one pair of rolls, nip pressure: 2000 N/cm).

### Dry Pick Resistance

Strips measuring 33×3 cm were cut in the longitudinal direction from the papers to be tested, and these strips were stored for 15 hours at 27° C. with a relative humidity of 50% in a conditioning chamber.

The strips were then printed on in a printing unit (IGT printability tester AC2/AIC2) using a standard ink (printing ink 3808 from Lorilleux-Lefranc).

The test strips are passed at continuously increasing speed (maximum speed 200 cm/sec) through the printing unit. The speed in cm/sec at which 10 picks from the paper coating slip (pick points) have occurred after the beginning of printing is stated as a measure of the dry pick resistance.

### Offset Test

Paper:

Samples measuring 240×46 mm are cut in the longitudinal direction from the papers to be tested.

### Carrying Out the Test:

An appropriate amount of printing ink is introduced onto the inking roll and allowed to run for 1 min. A printing disk is then inserted and inked for 30 s.

The printing speed is 1 m/s. A paper strip is placed on the print sample carrier with the printed paper strip brought back to the starting position. After a specified time span, the printing process is started again without exchanging the printing disk. This process is repeated several times.

After each pass, the picking on the printed side of the paper strip is visually assessed. The number of passes until picking occurs for the first time is stated.

### Statement of Result:

Number of printing processes until occurrence of the first pick.

| | Dry pick resistance | Offset test |
|---|---|---|
| Paper coating slip | (cm/s) | (number of passes) |
| S1 | 96 | 2 |
| S2 | 52 | 2 |
| S3 | 71 | 2 |
| S4 | 89 | 3 |
| S5 | 104 | 3 |
| S6 | 109 | 5 |

Thickener was used only in S1 (see above). Without thickener, the paper coating slips S2 to S6 achieve values which are just as good as, and with the higher proportion of anionic polymers better values than, paper coating slips based on emulsion polymers.

1: A paper coating slip comprising
a) one or more binders;
b) optionally, a thickeners
c) optionally, a fluorescent or phosphorescent dye, as an optical brightener;
d) pigments or fillers; and
e) further assistants selected from the group consisting of leveling agents and other dyes,
wherein at least 40% by weight of the total amount of the binders a) comprise a synthetic, water-soluble, anionic polymer and less than 50% by weight of the total amount of the binders a) are emulsion polymers.

2: The paper coating slip according to claim 1, wherein the anionic polymer comprises at least 0.01 mol of acid groups per 100 g of anionic polymer, and at least 20 mol % of the acid groups are present as a salt.

3: The paper coating slip according to claim 1, wherein the solubility of the anionic polymer in water is greater than 50 g of polymer/1 liter of water at 21° C. and 1 bar.

4: The paper coating slip according to claim 1, wherein the anionic polymer is a polymer obtained by the free radical polymerization of ethylenically unsaturated monomer compounds.

5: The paper coating slip according to claim 1, wherein at least 10% by weight of the monomers of which the anionic polymer is composed are acid monomers which comprise acid or salt groups.

6: The paper coating slip according to claim 1, wherein the acid monomers are selected from the group consisting of acrylic acid, methacrylic acid, maleic acid, and itaconic acid.

7: The paper coating slip according to claim 1, wherein the anionic polymer is additionally composed of at least 5% by weight of further monomers selected from ether monomers having at least one ether group or nitrogen monomers having at least one nitrogen atom.

8: The paper coating slip according to claim 1, wherein the nitrogen monomers are selected from the group consisting of vinylformamide, (meth)acrylamide, vinylpyrrolidone and vinylimidazole.

9: The paper coating slip according to claim 1, wherein the anionic polymer is a polymer composed of
from 5 to 95% by weight of acid monomers which comprise acid or salt groups,
from 5 to 95% by weight of nitrogen monomers selected from the group consisting of vinyl formamide, (meth)acrylamide, vinylpyrrolidone and vinylimidazole; and
from 0 to 30% by weight of auxiliary monomers.

10: The paper coating slip according to claim 1, wherein more than 60% by weight of the binders a) comprise an anionic polymer.

11: The paper coating slip according to claim 1, wherein less than 20% by weight of the binders a) are emulsion polymers.

12: The paper coating slip according to claim 1, comprising no emulsion polymers as binders.

13: The paper coating slip according to claim 1, wherein the amount of the binder a) is from 1 to 50 parts by weight per 100 parts by weight of pigments or fillers d).

14: A composition for coating paper and cardboard comprising the paper coating slip according to claim 1.

15: A paper or cardboard coated with a paper coating slip according to claim 1.
